(19) United States
(12) Patent Application Publication
(10) Pub. No.: US 2017/0072335 A1
(43) Pub. Date: Mar. 16, 2017

(54) Vacuum Distillation Unit

(71) Applicant: Jerry W. Noles, JR., Blanchard, OK (US)

(72) Inventor: Jerry W. Noles, JR., Blanchard, OK (US)

(73) Assignee: Noles Intellectual Porperties, LLC, Washington, OK (US)

(21) Appl. No.: 14/854,954

(22) Filed: Sep. 15, 2015

(51) Int. Cl. B01D 3/10; C02F 1/00; C02F 1/04

(52) U.S. Cl. CPC B01D 3/10; C02F 1/043; C02F 1/001

(57) ABSTRACT

A system for distilling a liquid having high levels of dissolved solids including an initial filter, a dynamic heat generator and a vacuum distillation unit. The liquid may be preheated by an exhaust gas or cooling fluid associated with a power source for operating the dynamic heat generator.

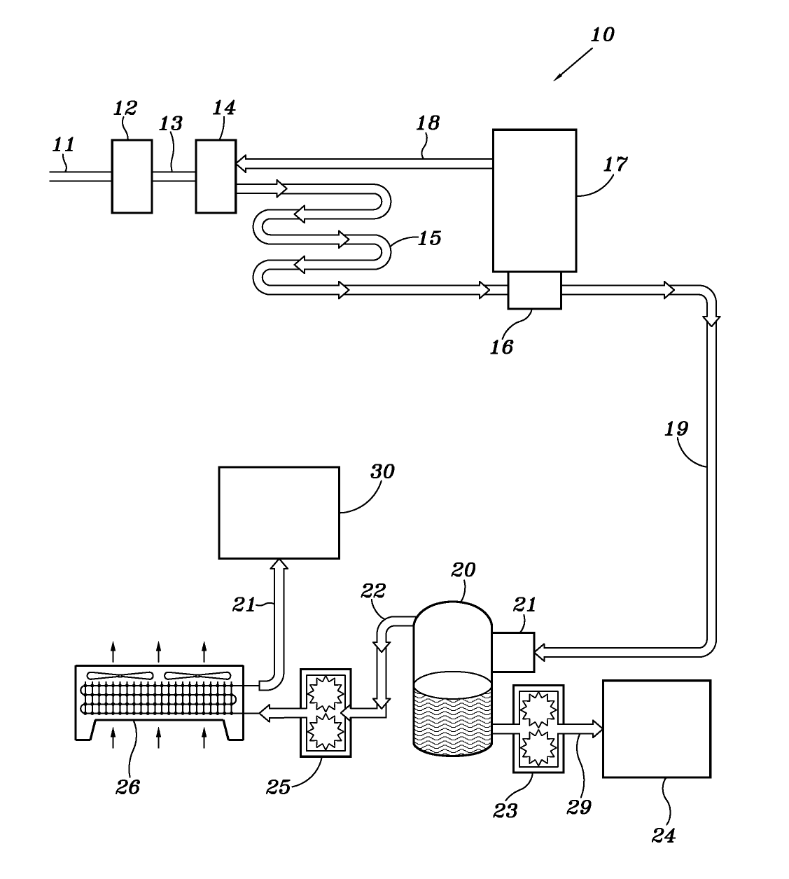

### BACKGROUND OF THE INVENTION

Field of the Invention

This invention relates to a method and apparatus for purifying contaminated fluid such as water which incorporate a vacuum distillation unit.

Description of Related Arts

In recent years water has become an increasingly important commodity. Global droughts coupled with population expansions within arid regions have left many communities without this natural resource for drinking and irrigation purposes. This has occurred while large volumes of water are being disposed of everyday in many industries because the quality of the water and its contaminants are not suitable for human consumption. Although the use of mechanical filtration such as reverse osmosis membrane systems have proven effective to clean water in the lower total dissolved solids ranges below 50,000 ppm, they have not proven effective at TDS levels above these limits. This is primarily due to the mechanical inability of the filters to handle high volumes of solids that are in solution within the water. When TDS levels exceed 50,000 ppm range one of the only proven methods to remove these solids and achieve a water quality suitable for discharge or reuse is distillation. Although distillation is very effective in removing high volumes of these solids it has not proven to be very energy efficient. For this reason many companies have explored the use of vacuum distillation to reduce the BTU requirements to bring the water to high enough temperatures to vaporize. Although this method has proven to be more thermally efficient than conventional distillation it still incorporates the use of tube and shell heat exchangers to bring the water to high enough temperatures. Boilers using flames generated by a fuel/air source transfer heat directly to a system of coils to capture as much of the fuels BTUs to heat the water are typically used. These boilers although well insulated cannot recover all of the BTUs that are generated before the air mass is moved out of the chamber and exhausted by the system. This thermal inefficiency has limited the commercial application of these systems on a large scale basis. It is for this reason that the need to find a more efficient system exists. This is increasingly apparent in the oil and gas industry where millions of gallons of this valuable resource are used and disposed of everyday in a process referred to as fracking. During frack operations large volumes of fresh water are used to help unlock the hydrocarbons that are trapped deep within the earth. This water is then recovered from the well where it has mixed with minerals and salts from the earth. Because the TDS levels are typically above the 50,000 ppm range this water is then disposed of by pumping it into deep reservoirs within the earth. This invention makes use of direct contact heat generated from the shear effect of a rotating and static plate design. These types of heaters have been used in many different industries to heat various fluids. However they have never been applied for the purpose of distillation. Part of the reason for this is fear that the corrosive nature of most contaminated fluids would limit the effectiveness of their application. To prevent this corrosive nature a secondary media such as antifreeze would need to be heated by the direct contact heater and with the use of a tube and shell heat exchanger the media would transfer the heat to the water. However this energy transfer reduces the thermal absorption characteristics of the water. During research and testing it was discovered that if the water were pre-filtered to a submicron level low enough to remove all of the suspended solids from the water then the water could be run into the direct contact heater without damage to the unit. In addition the use of a preset relief valve prevented the vacuum from being pulled directly on the heater. This is important to keep positive pressure on the cavity of the heater and to prevent the water from boiling off and allowing the solids to precipitate inside of the heater causing damage to the unit. It was also discovered that by using an engine driven by natural gas that the heat could be recovered from the engine cooling system to further enhance the effectiveness of the energy transfer and would provide maximum BTU transfer into the water thereby reducing the operating cost of the distillation unit. This proved to be extremely effective to assist in preheating the water prior to its introduction into the direct contact heater. This helped to drop the differential temperature between the entry of the water and the exit of the water into the vacuum distillation unit. This system reduced the thermal loses to that of the radiant heat from the engine case and small amounts of the engine exhaust system. This system proved to be so effective that it doubled the BTU absorption of the water. This allowed twice the volume of water to be distilled for the same fuel volume as that used in a conventional boiler system. In one embodiment this system has proven to be very effective in the distillation of oilfield produced water, bringing it to a dischargeable quality at a very low energy consumption. This also allows the brine to be condensed and the salt recovered from the system. It should be understood that the use of these (DHG) dynamic heat generators have not been used in this application because of the contaminates contained within the water. Waters that have high levels of (TSS) total suspended solids tend to be very abrasive and wear quickly on the tight tolerances within the heat generator. This required the heat generators to be used to heat a clean fluid media such as oil or Glycol and using a tube and shell heat exchanger. The BTUs are indirectly transferred to the water thus preventing wear or damage to the DHG. The problem with this method is the heat loss associated with this thermal transfer.

Consequently there is a need for a high volume energy efficient vacuum distillation system that is effective for fluids that have a high content of dissolved solids.

### BRIEF SUMMARY OF THE INVENTION

The present invention utilizes a dynamic heat generator to heat the fluid which has been passed through an initial filter for example a submerged membrane having a filter size of about 0.01 micros for example. This provides sufficient clean water to allow the use of a dynamic heat generator in conjunction with a vacuum distillation unit. The dynamic heat generator can be used in direct contact with the fluid thereby radically improving the thermal efficiencies and reducing heat losses. The heated fluid is then directly feed into the vacuum distillation unit. A relief valve is used to prevent vacuum from reaching the dynamic heat generator that could cause rapid pressure drops thereby allowing scale to precipitate within the dynamic heat generator instead of in the vacuum distillation unit.

### BRIEF DESCRIPTION OF THE DRAWINGS

The FIGURE illustrates a fluid purifying and vacuum distillation system according to an embodiment of the invention

### DETAILED DESCRIPTION OF THE INVENTION

As shown in the FIGURE, a system 10 according to an embodiment of the invention includes a source of fluid to be treated flowing in an inlet pipe 11. Pipe 11 is connected to an initial filter 12 which may be of the type having a submerged membrane having a filter size of about 0.01 micros for example. However any type of known micro filter may be used.

Fluid from filter 12 is directed to a preheater 14 having coils that are heated by cooling fluid or gases via a conduit 18 from a combustion type engine 17 which also serves as the power source for dynamic heat generator 16.

Consequently fluid exiting preheater 14 is heated to a certain degree prior to entering dynamic heat generator 16 via tubing 15. Dynamic heat generators are well known in the art, see for example U.S. Pat. No. 7,959,814, and include a pocketed rotor and end plates, a drive shaft and a group of rotating plates. Fluid entering the generator is heated by shearing force. A source of dynamic heat generator is Island City LLC located in Merrill, Wis.

The drive shaft of the generator is driven by a combustion engine 17. Heated fluid leaves the generator 16 via a conduit 19 which leads directly to a vacuum pot 20. A relief valve 21 is positioned in conduit 19 upstream of vacuum pot 20. Air and water vapor leave the upper portion of vacuum pot 20 by virtue of a vacuum pump 25 via conduit 22. Output from the vacuum pumps enter a condenser unit 26 in the vapor stage and is condensed and collected in a tank 30. Solids that accumulate in the bottom portion of vacuum pot 20 can be pumped out as a slurry by pump 23 connected to a holding tank or other receptacle 24 via conduit 29.

Although the present invention and its advantages have been described in detail, it should be understood that various changes, substitutions and alterations may be herein without departing from the spirit and scope of the invention as defined by the appended claims.

1. A vacuum distillation apparatus for fluids containing dissolved solids comprising
a) an initial fluid filter,
b) a dynamic heat generator having an inlet and outlet, the inlet connected to the initial fluid filter, and
c) a vacuum distillation unit having an inlet connected to the outlet of the dynamic heat generator, and including a vacuum pot and a condenser.

2. A vacuum distillation apparatus as claimed in claim 1 further including a fluid preheater connected between the initial fluid filter and the dynamic heat generator.

3. A vacuum distillation apparatus as claimed in claim 2 further including a combustion power source for driving a drive shaft of the dynamic heat generator and a conduit directing coolant fluid or exhaust gases from the combustion power source to the fluid preheater.

4. A vacuum distillation apparatus as claimed in claim 1 further including a relief valve connected between the dynamic heat generator and the vacuum distillation unit.

5. A vacuum distillation apparatus as claimed in claim 1 further including a pump for withdrawing solids that accumulate at the bottom of the vacuum pot.

6. A method of distilling a fluid haven dissolved solids therein comprising:
a. pre-filtering the fluid to remove some of the dissolved solids,
b. passing the fluid through a dynamic heat generator to raise the temperature of the fluid,
c. directing the fluid from the dynamic heat generator directly to a vacuum distillation unit for distillation.

7. The method of claim 5 further including:
providing a power source for the dynamic heat generator and using heat generated by the power source to preheat the fluid prior to entering the dynamic heat generator.
